(19) United States
(12) Patent Application Publication
(10) Pub. No.: US 2017/0063969 A1
(43) Pub. Date: Mar. 2, 2017

(54) SYSTEMS AND METHODS FOR CONTENT DISTRIBUTION

(71) Applicant: MOBEX, INC., Wilmington, DE (US)

(72) Inventor: Mitchel Lane Franks, Alpine, UT (US)

(21) Appl. No.: 15/199,433

(22) Filed: Jun. 30, 2016

Related U.S. Application Data
(60) Provisional application No. 62/187,060, filed on Jun. 30, 2015.

(51) Int. Cl. H04L 29/08; G06Q 30/02

(52) U.S. Cl. CPC H04L 67/10; G06Q 30/0277

(57) ABSTRACT

A content distribution service associates tags with specific digital content (e.g., a content feed) managed by a publisher. A client subscribes to a content feed by use of the tag assigned thereto. Subscribing to a tag may comprise receiving content from the publisher, including follow-up content. A client may receive additional follow-up content in response to certain conditions, such as client activity in the application, subscription to other tags, updates from the publisher, and/or the like. The client retains control over the tag subscriptions, and may unsubscribe and/or deactivate a tag at any time. Tag content may be distributed through a specialized communication channel that is separate from other, general-purpose communication channels of the client. The client may subscribe to a tag without exposing personal information to the publisher.

### TECHNICAL FIELD

This application claims priority to U.S. Provisional Patent Application No. 62/187,060 filed on Jun. 30, 2015, which is incorporated by reference in its entirety.

### TECHNICAL FIELD

This disclosure relates to content distribution and, in particular, to systems and methods for content distribution to one or more users through a network.

### BACKGROUND

The distribution of promotional content typically involves broadcasting information to users over available communication means, such as television, billboards, radio, Internet, and so on. Promotional content may include some kind of “call to action,” such as a prompt to call a telephone number, visit a particular business location, access a particular website, and/or the like. It may be difficult to immediately respond to such calls to action. Moreover, given the prevalence of promotional content, it may be difficult for consumers to remember specific details related to a call to action. Therefore, even when a consumer decides to act, the consumer may have difficulty responding (e.g., may have difficulty remembering the phone number to call, the address of the particular business, and/or the like). Some promotional content includes information intended to facilitate contact with the consumer, such as a QR code, audio registration, a “hashtag,” a Short Message Service (SMS) short code, Near Field Communication (NFC) distribution, and/or the like. Although these mechanisms may be useful in establishing an initial contact with a potential consumer, they do not provide mechanisms for the advertiser to follow-up. Although a QR code may simplify URL entry, such codes can be difficult to use and are only suitable for certain mediums (e.g., close-up print advertising and not TV or radio). Audio registration, through a service such as SHAZAM™ can be difficult to setup and relatively expensive for the advertiser. Hashtags in messaging services such as TWITTER™ do not provide for advertiser control and/or ownership, which can create substantial risks. Although SMS codes may be useful in establishing contact with potential customers, many are wary of providing contact details for their established, public communication channels due to, inter alia, concerns regarding privacy and control issues. NFC communication can enable device-to-device communication, but requires specialized hardware, can be difficult and expensive to maintain, only applies to close-up print advertising and may also raise significant privacy concerns.

In many cases, the promotional content is intended to establish a point of contact between the advertiser and customer. Advertisers typically engage customers through general-purpose communication channels, such as email, SMS (e.g., text messaging), instant messaging, telephone, and/or the like. Some consumers, however, may be hesitant to engage with advertisers through general-purpose communication channels due to, inter alia, privacy concerns. For example, once a consumer provides an advertiser with contact information pertaining to a general-purpose communication channel, the consumer runs the risk that the contact information will be disseminated to other entities, leaked, used to send unwanted communication (e.g., spam), and/or the like. Therefore, what are needed are systems and methods for content distribution that facilitate customer engagement while mitigating privacy concerns.

### BRIEF DESCRIPTION OF THE DRAWINGS

FIG. 1 is a schematic block diagram of one embodiment of a system for content distribution;

FIG. 2 depicts embodiments of records for managing content distribution;

FIG. 3 depicts one embodiment of a subscription interface of a client-side application of the content distribution system;

FIG. 4 depicts embodiments of records for managing subscriptions;

FIG. 5 depicts embodiments of records for distributing content to client applications;

FIG. 6A depicts embodiments of a content interface of a mobile computing device;

FIG. 6B depicts further embodiments of a content interface of a mobile computing device;

FIG. 6C depicts further embodiments of a content interface of a mobile computing device;

FIG. 6D depicts further embodiments of input elements of a content interface of a mobile computing device;

FIG. 7 is a flow diagram of one embodiment of a method for content distribution;

FIG. 8 is a flow diagram of embodiments of operations and data relationships for content distribution;

FIG. 9 is a flow diagram of another embodiment of a method for content distribution;

FIG. 10 is a schematic block diagram of another embodiment of a system for content distribution;

FIG. 11A depicts one embodiment of an interface for provisioning a tag;

FIG. 11B depicts one embodiment of an interface for distributing content associated with a tag;

FIG. 12 depicts one embodiment of an interface for displaying metrics pertaining to content distribution;

FIG. 13 is a flow diagram of another embodiment of a method for content distribution; and

FIG. 14 is a flow diagram of another embodiment of a method for content distribution.

### DETAILED DESCRIPTION

Disclosed herein are systems and methods for content distribution. The systems and methods disclosed herein may facilitate customer engagement through a specialized content delivery channel that is separate from other, general-purpose communication channels. As disclosed herein, a customer may engage with an advertiser or an individual may engage with another individual (i.e. social media) through the specialized content delivery channel without exposing identifying information to the advertiser and/or without exposing contact information pertaining to other, general-purpose communication channels of the customer (e.g., email address, telephone number, mobile telephone number, and/or the like).

In some embodiments, a content distribution service associates “tags” with respective content feeds. As used herein, a “tag” and/or “tag indicia” refers to any data usable to act as an identifier including, but not limited to: a character, a sequence of characters, a word, a phrase, a symbol, an image, and/or the like. As used herein, a “content feed” refers to a set of one or more content items capable of being displayed on a computing device, a content item may include, but is not limited to: text content, image content, audio content, video content, multimedia content, executable code, renderable content, markup content (e.g., Hyper Text Markup Language (HTML) content), structured content (e.g., eXtensible Markup Language (XML) content), unstructured content, a file or document and/or the like. A content feed may comprise promotional material, an advertising campaign, social media information, and/or the like. A content feed may correspond to a plurality of tags, a particular date range, and/or the like. In some embodiments, a content feed refers to a set of one or more tags (and corresponding content items). The content distribution service may be further configured to associate tags and/or content feeds with respective publishers. As used herein a “publisher” refers to an entity that is authorized to publish content items to one or more content feeds managed by the content distribution service. A publisher may be a business, an advertiser, an organization, an individual, and/or the like.

The content distribution service may be configured to publish content to users through, inter alia, a specialized content delivery channel. The specialized content delivery channel may be separate from other, general-purpose communication channels, such as email, telephone, text messaging, instant messaging, TWITTER™, and so on. In some embodiments, the specialized content delivery channel comprises a client application of the content distribution service configured for operation on the mobile computing device (a client application). The client application may comprise a subscription interface configured to enable a user to subscribe to particular tags. Subscribing to a tag may comprise subscribing to the content feed assigned to the particular tag. The subscription interface may provide an input to receive tag indicia, such as a text input, an audio input, a speech input, an image input (e.g., camera input), a video input, and/or the like. In response to receiving tag indicia, the client application may transmit a subscription request to the content distribution service. The subscription request may include the tag indicia and/or a subscriber identifier. In response, the content distribution service may record that the identified subscriber is subscribed to the designated tags (and corresponding content feeds). Subscribing to a tag may comprise transmitting content item(s) published to the content feed of the tag to the client application through a network. The client application may comprise a display interface configured to display information pertaining to subscribed tags, content feeds, and/or content items of the respective tags and/or content feeds. The client application may further include an interface for modifying and/or removing subscriptions. Removing a subscription may comprise transmitting an unsubscribe request to the content distribution service comprising tag indicia of the unsubscribed content feeds. In response, the client distribution service may be configured to record that the identified subscriber is no longer subscribed to one or more tags, such that content items published to the content feeds are no longer published and/or distributed to the identified subscriber.

As disclosed above, the content distribution service may associate publishers with respective tags (and/or content feeds). The content distribution service may be configured to publish content items to the content feeds of the tags in response to content publication requests. A content publication request may comprise one or more content items and indicia of the tag(s) to which the content item(s) are to be published. In one embodiment, a publication request comprises the content item to be published, and the content distribution service distributes the content item to the client application(s) subscribed to the corresponding tags. Alternatively, or in addition, a content publication request may reference content that is hosted by another entity (e.g., a content hosting service, such as a website, cloud storage system, and/or the like), and the content distribution system may be configured to publish the reference(s) and/or link(s) to the content to the identified tag(s) and/or content feeds. In another embodiment, a content publication request comprises a combination of content item(s) and references to externally hosted content, and the content distribution service may be configured to publish the content item(s) and links to externally hosted content to the identified tags and/or content feeds. Publishing content to a tag and/or content feed may comprise transmitting a publication message to the client application(s) subscribed to the tag and/or content feed. The publication message may comprise one or more content item(s), may comprise a reference to content item(s) hosted by the content distribution service, may comprise a reference to content item(s) hosted by another entity, and/or the like. The client application may be configured to present the published content items to a user through, inter alia, the content interface thereof, as disclosed herein.

Users may subscribe to tags by transmitting indicia of the tags to the content distribution service. In some embodiments, an advertiser may publish advertising content that includes a designated tag. Accordingly, the “call to action” of the advertising content may comprise a prompt to subscribe to the designated tag, through the client application. As disclosed herein, subscribing to a tag may comprise subscribing to a content feed assigned to the tag by the content distribution service (and provisioned to the advertiser). As disclosed in further detail herein, the client application may provide a simple, easy-to-use interface for entering tag information, which may lower the barrier to entry for responding to the call to action of the advertising content. Moreover, the tag entry and/or content feed may be handled through the client application that is separate from other communication channels of the user, which may mitigate privacy and/or spam concerns. In some embodiments, the user retains complete control over subscriptions of the client application, and may access content feeds anonymously through the client application (e.g., without exposing personally identifying information to the advertiser and/or content distribution service).

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers, computer programming tools and techniques, computer networks and networking technologies, digital storage media, authentication, access control, and other security tools and techniques provided by public keys, encryption, firewalls, and/or other means.

The embodiments of the disclosure are described below with reference to the drawings, wherein like parts are designated by like numerals throughout. The components of the disclosed embodiments, as generally described and illustrated in the figures herein, could be arranged and designed in a wide variety of configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

Disclosed herein are embodiment of systems and methods for a) creating a tag, such as a word, phase, alphanumeric, symbol, and/or the like, and b) linking the tag to specific content. Content linked to particular tags may be maintained and/or published by a network-accessible content distribution service. Clients may access content linked to particular tags by use of a client application. A user may request information pertaining to a particular tag by providing the corresponding tag indicia to the client application. The client application may establish a communication channel to the content distribution service that is separate from and/or independent of other, general purpose communication channels of the user. Content related to a tag may be downloaded to the client application for access at a later time. Additional content items may be published to particular tags. The additional content items may be automatically published to client applications that have subscribed to the particular tags. The additional content items may be published as received at the content distribution service, may be distributed according to a particular schedule, in response to a particular condition (e.g., trigger), and/or the like. A publisher may modify the content associated with a particular tag and/or specify when content of a particular tag is enabled for distribution. The content distribution service may track metrics pertaining to the tags and/or content items, such as the number of subscribers, subscriber location, follow-up rate, source of subscription (e.g., subscribed in response to a particular ad, such as a radio ad, billboard, and/or the like), and so on. In some embodiments, the client application maintains demographic information pertaining to subscribers and associates such demographic information with the metrics disclosed herein.

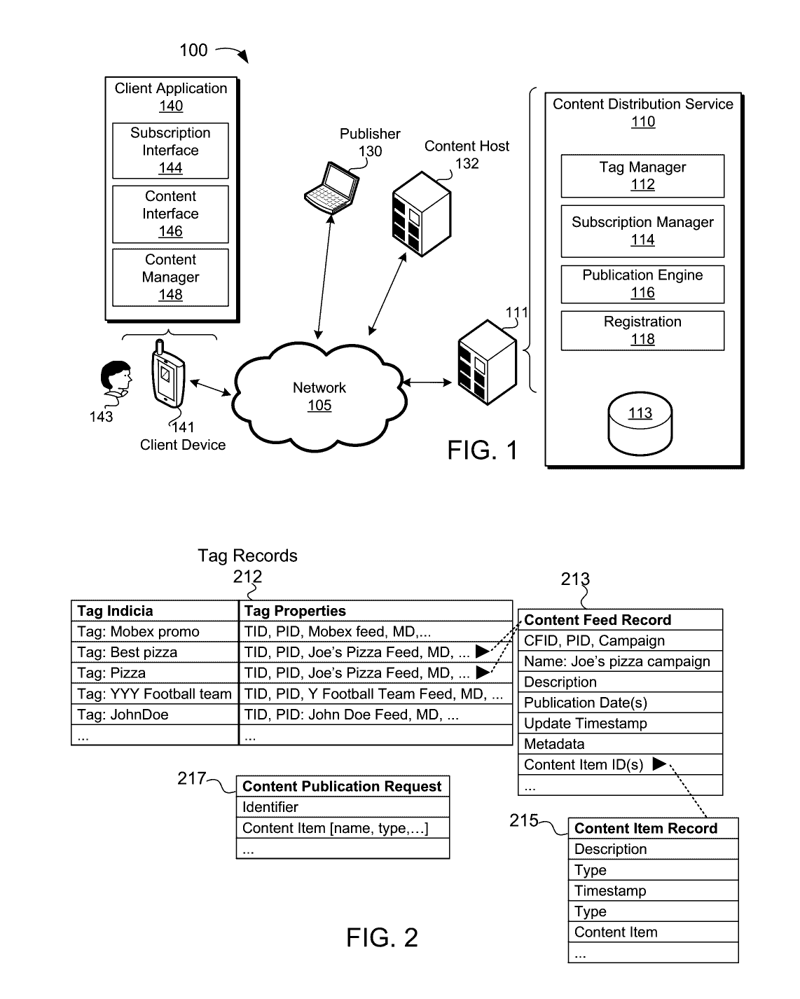

FIG. 1 is a schematic block diagram of one embodiment of a system 100 for content distribution. The system 100 comprises a content distribution service 110, which may be implemented on a content distribution server 111. Although not depicted in FIG. 1 to avoid obscuring the details of the illustrated embodiments, the content distribution server 111 may comprise a processor, volatile memory, non-transitory machine-readable storage, human-machine interface (HMI) components (e.g., a keyboard, mouse, display, and so on), communication interface(s), including a communication interface to communicatively couple the content distribution server 111 to the network 105, and so on. Although FIG. 1 depicts a single content distribution server 111, the disclosure is not limited in this regard and could be adapted to use multiple content distribution servers 111 corresponding to separate computing devices and/or content distribution server(s) 111 hosted in a virtual computing environment (e.g., multiple content distribution server(s) 111 hosted on a single computing device).

The system 100 may further comprise a content distribution service 110, which may be implemented by use of and/or embodied on the content distribution server 111. In the FIG. 1 embodiment, the content distribution service 110 comprises a tag manager 112, publication engine 116, subscription manager 114, a registration module 118, and non-transitory data store 113. In some embodiments, the content distribution service 110 and the components thereof are embodied as executable instructions stored on a non-transitory storage medium, such as the non-transitory data store 113. The instructions may be configured for execution by a processor to implement the functionality of the content distribution service 110, as disclosed herein. Alternatively, or in addition, the content distribution service 110 and/or the components thereof may comprise hardware elements, such as a circuit, an application-specific integrated circuit (ASIC), a programmable circuit, such as a Field Programmable Gate Array (FPGA), a controller, a programmable logic element, and/or the like.

As disclosed in further detail herein, the tag manager 112 may be configured to associate tags with specific digital content; the subscription manager 114 may be configured to manage subscriptions to particular tags and/or content feeds managed by the content distribution service 110; the publication engine 116 may be configured to distribute content to client application 140 through the network and/or receive content to be published to the tags and/or content feeds managed by the content distribution service 110; and the registration module 118 may be configured to manage registration information pertaining to publishers (e.g., publisher 130), users 143, and so on.

In the FIG. 1 embodiment, the tag manager 112 assigns tags to respective content feeds (by use of content feed identifiers). As disclosed herein, a tag may refer to any suitable identifier for a content feed, such as a character, text, a phrase, a symbol, an image, audio data, and/or the like. As disclosed herein, a content feed refers to a set of one or more content items managed by a publisher, such as publisher 130. The tag manager 112 may be configured, therefore, to provision tags to particular publishers 130, and to associate the tags with respective content feed identifiers and/or publishers 130 in the non-transitory data store 113. FIG. 2 depicts one embodiment of tag records 212 for defining tags, assigning tags to publishers, and/or associating tags with specific digital content (e.g., specific content feeds and/or items). As used herein, a “record,” such as a tag record 212, refers to any suitable format and/or technique for data storage. Accordingly, a record may refer to one or more of: a data structure, a database record, a directory entry, a file, XML structured data, unstructured data, and/or the like. A record may be stored on a machine-readable, non-transitory storage medium, such as the non-transitory store 113.

The tag records 212 illustrated in FIG. 2 comprise respective tag indicia including a “Mobex promo” tag, a “Best pizza” tag, a “pizza” tag, a “YYY Football team” tag, and so on. A tag record 212 may link respective tags' indicia with tag properties, which may include, but are not limited to: a tag identifier (TID), a publisher identifier (PID) that assigns the tag to a particular publisher 130, a name, tag metadata (MD), and so on. The tag metadata may be used to track metrics pertaining to a tag record 212, such as number of subscribers to the tag, tag views, tag response rate, tag response time, and so on. In some embodiments, a plurality of tags may correspond to a single content feed. As illustrated in FIG. 2, the tags “Best pizza” and “pizza,” both correspond to “Joe's pizza feed.” A TID may comprise and/or be derived from the tag indicia (e.g., may comprise the tag indicia and a publication timestamp, or other identifier). Although FIG. 2 depicts tag indicia as text, the disclosure is not limited in this regard. In some embodiments, the tags may comprise different indicia, such as images, audio, and/or the like. A TID and/or PID may comprise any suitable identifier, such as a globally unique identifier (GUID), a key (e.g., a primary key), a distinguished name, a Uniform Resource Identifier (URI), a Uniform Resource Locator (URL), and/or the like.

As disclosed in further detail herein, the content distribution service 110 may be configured to track information regarding various tags by use of respective tag records. Such tracking may include, but is not limited to: tracking the number of subscribers to the tag, response rate to content published to the tag (and/or other metrics), publication activity, search activity, and so on.

The tag records 212 may be further configured to associate tags with respective content feed records 213 (e.g., by use of respective content feed identifiers). A content feed identifier may comprise any suitable identifier and/or reference to a content feed record 213, such as a GUID, key, primary key, distinguished name, URI, URL, and/or the like. A content feed record 213 may comprise information pertaining to one or more tags. Accordingly, a content feed record 213 may correspond to a campaign of an advertiser. In some embodiments, the content feed record 213 (and the corresponding tag records 212) are associated with a particular campaign. As depicted in FIG. 2, the content feed record 213 may also include, but is not limited to: an identifier (a content feed identifier or CF ID), a PID of the publisher 130 that is authorized to manage the content feed record 213 (and/or the tag records 212 associated therewith), a campaign, a name and/or other indicia of the content feed, a description, a publication date range(s) for the content feed, an update timestamp indicating the last time the content pertaining to the content feed was published and/or modified, references to the content item(s) that have been published to the content feed, content feed metadata (MD), and so on. Accordingly, a tag record 212 may associate a tag and/or publisher 130 with specific digital content (e.g., content items of a particular content feed).

Although not depicted in FIG. 2 to avoid obscuring the details of the disclosed embodiments, the PID of the content feed record 213 may reference a separate publisher record stored on the non-transitory store 113. A publisher record may identify the publisher 130 that is authorized to manage a particular content feed (and corresponding tags). The publisher record may further identify users that are authorized by the publisher 130 to publish and/or modify content items of the content feed. The publisher 130 and/or authorized user(s) thereof may be identified by use of distinguished names, user identifier(s), GUIDs, and/or the like. Alternatively, or in addition, the publisher 130 and/or authorized user(s) may be associated with authentication credentials which may be used to authenticate the publisher 130 and/or authorized user(s), to provide secure access to publication and/or management functionality of the content distribution service 110, as disclosed herein (e.g., the publisher interface 117, described in further below). The registration module 118 of the content distribution service 110 may be configured to manage information pertaining to the publisher 130, authorized users of the publisher 130, and/or users 143 on the non-transitory store 113, as disclosed in further detail herein.

A content feed record 213 may be associated with a campaign. As disclosed above, a campaign refers to a collection of one or more tags (and corresponding content) managed by a publisher 130. A campaign may comprise tags and/or content pertaining to a particular promotion, geographical location, season, and/or the like.

A content feed record 213 may identify one or more content item(s) that have been published thereto. In the FIG. 2 embodiment, the content feed record 213 comprises one or more content item identifier(s) that correspond to respective content item records 215. A content item record 215 may comprise information pertaining to a content item published to one or more tags and/or content feeds and may include, but is not limited to: a name of the content item, a type (e.g., text, video, HTML, multimedia, etc.), a publication timestamp indicating the time the content item was published (and/or modified), a publication type indicating how the content item is to be distributed to subscribers of the content feed, the content item, and so on. In some embodiments, a content item record 215 may comprise the content item itself (e.g., the content item may be hosted by the content distribution service 110). Alternatively, or in addition, portions of the content item may be hosted by a separate server of the content distribution service 110, the publisher 130, and/or another third party (e.g., content host 132). A content item record 215 may, therefore, comprise a reference to the content item (e.g., URI and/or URL of the content item). In some embodiments, the content item record 215 comprises a combination of locally and externally hosted content (e.g., content stored within the content item record 215 and content hosted by a publisher 130 and/or content host 132). As disclosed above, the publication type of the content item record 215 may indicate how and/or when the corresponding content item is to be published to users 143. In some embodiments, the publication type may indicate that the content item is to be sent to users as the users subscribe to the content feed (e.g., an “initial” or “base” content item). Alternatively, the publication type may indicate that the content item is to be sent as a follow-up to subscribers in response to some other trigger condition, such as a promotion or the like. In one embodiment, the publication type indicates that the content item is to be sent to subscribers during a particular date and/or time period. After the designated period, the content item may expire, such that the content item is no longer sent to subscribers (and/or the corresponding data item record 215 may be removed from the non-transitory data store 113).

The publication engine 116 of the content distribution service 110 may be configured to receive content publication requests 217 from publishers 130. A content publication request 217 may comprise a request to publish one or more content items to a particular tag and/or content feed. As illustrated in FIG. 2, a content publication request 217 may include an identifier and one or more content items. The identifier may comprise a tag, a content feed identifier, and/or the like. The content item(s) may comprise content to be hosted by the content distribution service and/or content hosted by another entity (e.g., the publisher 130, content host 132, and/or the like). Although not depicted in FIG. 2, the content publication request 217 may further include authentication credentials to enable the content distribution service 110 to authenticate that the content publication request 217 was received from a publisher 130 authorized to manage the tags and/or content feeds specified in the content publication request 217. In response to receiving and authenticating a content publication request 217, the publication engine 116 may be configured to update the tag(s) and/or content feed(s) designated therein. The publication engine 116 may be configured to a) identify the content feed record 213 corresponding to the content publication request 217, b) create one or more new content item records 215 for the content item(s) included in the content publication request 217, and c) associate the new content item records 215 with the identified content feed record 213. The publication engine 116 may be further configured to set the update timestamp of the content feed record 213 to the time at which the content publication request 217 was processed. In some embodiments, the publication engine 116 is further configured to push the new content to one or more client applications 140 through the network 105. Alternatively, or in addition, the publication engine 116 may be configured to transmit the new content item(s) in response to content requests from respective client applications 140.

As disclosed herein, the content distribution service 110 may be configured to distribute content to client devices 141 through the network 105. As used herein, a client device 141 refers to any computing device comprising a client application of the content distribution service 110 (client application 140). A client device 141 may include, but is not limited to: a computing device, a personal computer, a desktop computer, a mobile computing device, a laptop, a notebook, a tablet computer, a personal digital assistant, a smart phone, and/or the like. The client application 140 may be configured to communicate with the content distribution service 110 through, inter alia, the network 105. The client application 140 may comprise a subscription interface 144 for managing subscriptions pertaining to the content delivery service 110 and/or a content interface 146 configured to display content items and/or content feeds on the client device 141. The client application 140 may further include a content manage 148 configured to manage content items and/or content feeds stored on the client device 141 for display by the content interface 146.

The client application 140 may be installed on the client device 141 by use of an application distribution platform (e.g., an Application Store), by downloading the application from the content distribution service 110 and/or other source, and/or the like. Installing the client application 140 may comprise transferring executable code comprising the client application 140 from a network-accessible storage location, and storing executable code on a non-transitory storage medium of the client device 141.

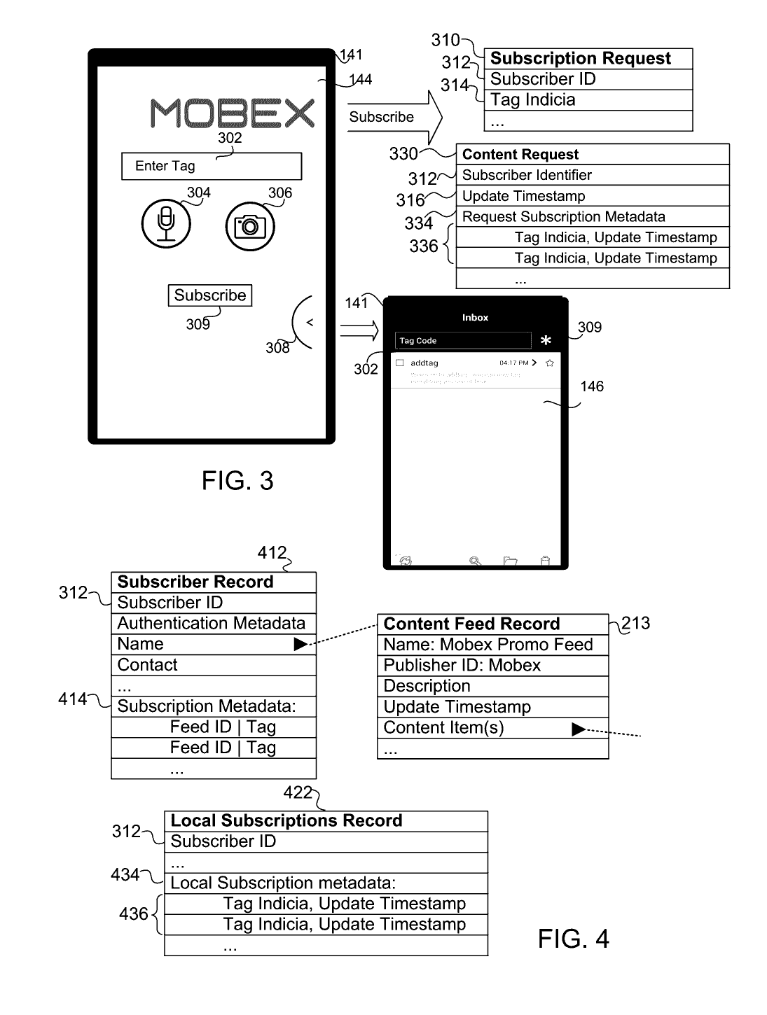

The subscription interface 144 of the client application 140 may comprise an interface for subscribing to a content feed managed by the content distribution system. FIG. 3 depicts one embodiment of a subscription interface 144 of the client application 140. The subscription interface 144 may be configured for use on a mobile computing device comprising a touch screen, such as a smartphone, tablet, and/or the like. The disclosure is not limited in this regard, however, and could be adapted for use with any suitable computing device having any suitable HMI components. As depicted in FIG. 3, the subscription interface 144 may comprise a text tag input 302. Selecting the text tag input 302 (by use of a touch screen or pointer input) may invoke a text input element on the subscription interface 144, such as an on-screen keyboard (not shown). Alternatively, or in addition, a user may enter text into the text tag input 302 by use of a hardware keyboard of the computing device and/or other HMI component. The subscription interface 144 may further comprise an audio input 304. The audio input 304 may be configured to capture an audio signal by use of a microphone of the mobile computing device (and/or other HMI component). In response, the client application 140 may perform a speech-to-text operation to convert the captured audio signal to text, which may be used as tag indicia (and/or used to populate the text input 302). Alternatively, the audio tag input 304 may use the captured audio signal as tag indicia. The subscription interface 144 may further include an image input 306. In some embodiments, selection of the image input 306 invokes a camera application of the client device 141. The subscription interface 144 may be configured to use one or more images captured by use of the camera as tag indicia. In some embodiments, the subscription interface 144 is configured to extract text from the image (e.g., perform Optical Character Recognition (OCR) to identify text within one or more captured images). The extracted text may be used as tag indicia (and/or to populate the text input 302). In some embodiments, a tag may be encoded as a QR code, and the subscription interface 144 may be configured to capture an image of the QR code and to derive text tag indicia therefrom. Alternatively, in other embodiments, the image itself may be used as tag indicia.

The subscription interface 144 may further include an input 308 to access the content interface 146 of the client application 140. Selection of the input 308 may invoke the content interface 146 on the mobile computing device 141. FIG. 3 illustrates one embodiment of a content interface 146. In the FIG. 3 embodiment, the user 143 of the client application 140 has not subscribed to any content feeds and, as such, there are no content feeds displayed within the content interface 146. The content interface 146 may include a text input 302 for entering tag indicia and/or a subscribe input 309, as disclosed above. The content interface 146 may further comprise a link for accessing the subscription interface 144 (e.g., the “addtag” element in the content interface 146).

The subscription interface 144 may further comprise a subscribe input 309. In response to selection of the subscribe input 309, the client application 140 may subscribe to content feeds corresponding to one or more tags entered by use of the subscription interface 144. In some embodiments, the content distribution service 110 manages subscription information pertaining to particular users 143 and/or client applications 140. Alternatively, tag subscriptions may be managed locally on the client device 141 by the client application 140.

In embodiments in which the content distribution service 110 manages subscription information, the client 140 may be configured to generate and transmit a subscription request 310 in response to selection of the subscribe input 309. As illustrated in FIG. 3, the subscription request 310 may comprise a subscriber identifier 312 and tag indicia 314. The tag indicia 314 may comprise the contents of one or more of the text input 302, audio input 304, and/or image input 306. Alternatively, or in addition, the tag indicia 314 may comprise information derived from audio, image, and/or video content captured by use of one or more of the audio input 304 and/or camera input 306, such as text from a speech-to-text operation on audio input, tag indicia decoded from an image, and/or the like. The subscriber identifier 312 may identify the entity that wishes to subscribe to the specified tags (e.g., subscribe to content feed(s) associated with the provided tag indicia 314). The subscriber identifier 312 may comprise any suitable identifier including, but not limited to: a name, a user name, an authentication credential, a distinguished name, an email address, a GUID, and/or the like. In some embodiments, the subscriber identifier 312 corresponds to the user 143 of the client application 140. Accordingly, the subscriber identifier 312 may comprise a user name, a user email address, a user account identifier, an authentication credential and/or the like. Alternatively, the subscriber identifier 312 may be configured to maintain anonymity for the user 143. In such embodiments, the subscriber identifier 312 may comprise a generic identifier, which may comprise and/or be derived from information pertaining to the client device 141 (e.g., a Media Access Control (MAC) address, a hardware identifier, and/or the like), an identifier arbitrarily generated by the client application 140 and/or assigned to the client application 140 by the content distribution service 110, and/or the like. In some embodiments, the subscriber identifier 312 corresponds to an authentication credential, which may be used to authenticate the subscription request 310. As disclosed in further detail herein, in some embodiments, the subscriber identifier 312 comprises and/or corresponds to a subscriber record maintained on the non-transitory store 113 of the content distribution service 110.

In response to the subscription request 310, the subscription manager 114 of the content distribution service 110 may be configured to a) identify content feed(s) corresponding to the tag indicia of the subscription request 310 (by use of the tag records 212), and b) record that the subscriber identifier 312 is subscribed to the identified content feed(s). Referring to FIG. 4, the subscription manager 114 may record information pertaining to content feed subscriptions by use of subscriber records 412. A subscriber record 412 may comprise a subscriber identifier 312, as disclosed herein. The subscriber identifier 312 may further include an authentication credential for use in authenticating messages associated with the subscriber identifier 312. The authentication credential may include, but is not limited to: a signature, a public key, a shared secret, metadata derived from a shared secret (e.g., a password hash), and/or the like. In some embodiments, the subscriber record 412 includes information pertaining to a particular user 143, such as name, contact information (e.g., email address), and so on. In other embodiments, a subscriber record 412 may not include user-identifying information (e.g., an anonymous or generic subscriber record).

The subscription manager 114 may track subscription information in the subscriber record 412. Accordingly, the subscriber record 412 may comprise subscription metadata 414 that, inter alia, identifies the tag subscriptions of the particular subscriber. The subscription metadata 414 may comprise references to respective tags (tag indicia) and/or content feeds (e.g., identifiers of respective tags, tag records, and/or content feed records 213). The subscription metadata 414 may be updated in response to subscription requests 310 from the particular subscriber identifier 312, as disclosed herein.

Referring back to FIG. 3, in some embodiments, the content manager 148 of the client application 140 is configured to maintain subscription information on the client device 141. In response to selection of the subscribe input 309, the content manager 148 may be configured to record subscription information locally, on the client device 141. As illustrated in FIG. 4, in some embodiments, the content manager 148 records subscription information in a local subscriptions record 434, which may be stored on non-transitory storage of the client device 141. The local subscriptions record 434 may include a subscriber identifier 312, which, as disclosed above, may correspond to the user 143 of the client application 140 and, as such, may comprise user profile information, such as user name, contact information, authentication metadata, and so on. Alternatively, the subscriber identifier 312 may comprise an anonymous identifier that does not comprise and/or correspond to personally identifying information of the user 143. The local subscriptions record 434 may further comprise local subscription metadata 414. The tag subscription metadata 414 may identify tag and/or content feed subscriptions by use of respective tag subscription entries 436. The tag subscription entries 436 may identify tag and/or content feed subscriptions by use of tag indicia. The tag subscription entries 436 may further comprise an update timestamp that indicates a last update time for the content feed(s) corresponding to the particular tags. At initial subscription to a tag and/or content feed, the update timestamp of the corresponding tag subscription entry 436 may be initialized to “0” (or some other default value), indicating that the tag and/or content feed has never been updated on the particular client device 141.

In some embodiments, subscription information is recorded by both the content distribution service 110 and the client application 140 (on the client device 141 by the content manager 148). In response to selection of the subscribe input 309, the client application 140 may be configured to a) generate and transmit a subscription request 310 to the content distribution service 110, and b) record subscription information in a local subscriptions record 434, as disclosed herein.

The client application 140 may be further configured to request content pertaining to tag subscriptions. In some embodiments, the client application 140 requests content by, inter alia, generating and transmitting a content request 330 to the content distribution service 110. In some embodiments, the content request 330 comprises a subscriber identifier 312, as disclosed herein. In embodiments in which the content distribution service 110 maintains subscription information for the client application 140, the content distribution service 110 may use the subscriber identifier 312 to identify a subscriber record 412 maintained on the non-transitory store 113, which may include subscription metadata 414 that identifies the tags and/or content feeds to publish in response to the content request 330. Alternatively, or in addition, the content request may comprise request subscription metadata 334. In some embodiments, the request subscription metadata 334 is derived from a local subscriptions record 434 maintained on the client device 141. The request subscription metadata may identify the tags and/or content feed(s) requested by the client application 140 (by use of respective tag subscription entries 436). The tag subscription entries 436 may specify a tag and/or content feed (e.g., by use of tag indicia, a content feed identifier, and/or the like). In some embodiments, the tag subscription entries 436 comprise respective update timestamps that indicate a last update time for the corresponding tags and/or content feeds. If the content request 330 is generated in response to a new subscription to the tag and/or content feed, the timestamp 316 thereof may be set to “0” (or another default value), indicating that the content has never been updated on the particular client device 141. Alternatively, or in addition, the content request 330 may comprise a single update timestamp 316 indicating a last update time of all the tags and/or content feeds specified in the content request 330.

The client application 140 may transmit the content request 330 to the content distribution service 110 through the network 105. In response, the content distribution service 110 may identify content items pertaining to the specified tags and/or content feeds and publish the identified content items to the client application 140. Referring back to FIG. 1, the content distribution service 110 may further comprise a publication engine 116 configured to publish content of one or more tags and/or content feeds managed by the content distribution service 110. The publication engine 116 may be configured to publish content in response to one or more of a) a subscription request 310 from a client application 140, b) a content request 330 from a client application 140, c) publication and/or modification of content items of one or more content feeds, d) other trigger conditions, and/or the like. Publishing content may comprise a) pushing content to one or more mobile computing devices 141 through the network 105, b) providing content to one or more mobile computing devices 141 in response to a request (e.g., a subscription request 310, content requests 330, etc.), and/or the like.

As disclosed above, the client application 140 may be configured to transmit a subscription request 310 and/or content request 330 to the content distribution service 110 in response to user interaction with the subscription interface 144. In response to a subscription request 310, the subscription manager 114 may be configured to record a subscription record that the subscriber identifier 312 is subscribed to the content feed(s) corresponding to the tag indicia 314 included in the subscription request 310. The subscription manager 114 may be configured to identify a content feed record 213 assigned to the tag indicia 314 of the subscription request 310, and record the subscription in a subscriber record 412, as disclosed herein. In addition, the publication engine 116 may be configured to respond to the subscription request 310 with one or more content items of the identified content feed record 213. In some embodiments, the publication engine 116 returns the content item corresponding to the first (or only) content item record 215 of the content feed record 213. In some embodiments, the identified content feed record 213 comprises a plurality of content item identifiers (e.g., the publisher 130 may have published a plurality of content items to the particular tag and/or content feed). The publication engine 116 may select one or more of the plurality of content items to send to the client application 140. In one embodiment, the publication engine 116 selects the first and/or current content item record 215 of the content feed record 213 to publish to the client application 140. In one embodiment, the publication engine 116 selects a content item record 215 published and/or designated as “active” (in the type field) at the time of the subscription request 310 (e.g., the content item record 215 currently active at the time the user subscribed to the corresponding tag). In another embodiment, the publication engine 116 may select a content item record for publication based on, inter alia, properties of the content item record(s) 215. The publication engine may select a content item based on a status, date and time stamp and so on. The publication engine 116 may select a content item record 215 based on the value of a “type” field in the content item record 215 (e.g., whether the type is “initial,” “follow-up,” or the like). The publication engine 116 may select a content item record 215 assigned a type of “initial,” in response to a subscription request 310.

The publication engine 116 may be further configured to respond to publication requests 330 issued by the client application 140 after initial subscription to particular tags and/or content feeds. As disclosed in further detail herein, the content manager 148 of the client application 140 may be configured to generate and transmit publication requests 330 to the content distribution service 110. The publication requests 330 may identify tag and/or content feed subscriptions and/or indicate the last update time of the identified tags and/or content feeds. In response to a publication request 330, the publication engine 116 may identify the content feed records 213 corresponding to the specified tags and/or content feeds and determine whether updated content is available based on, inter alia, the last update time of the corresponding tags and/or content feeds indicated in the content request 330. The publication engine 116 may return updated content to the client application 140 in response to the content request 330.

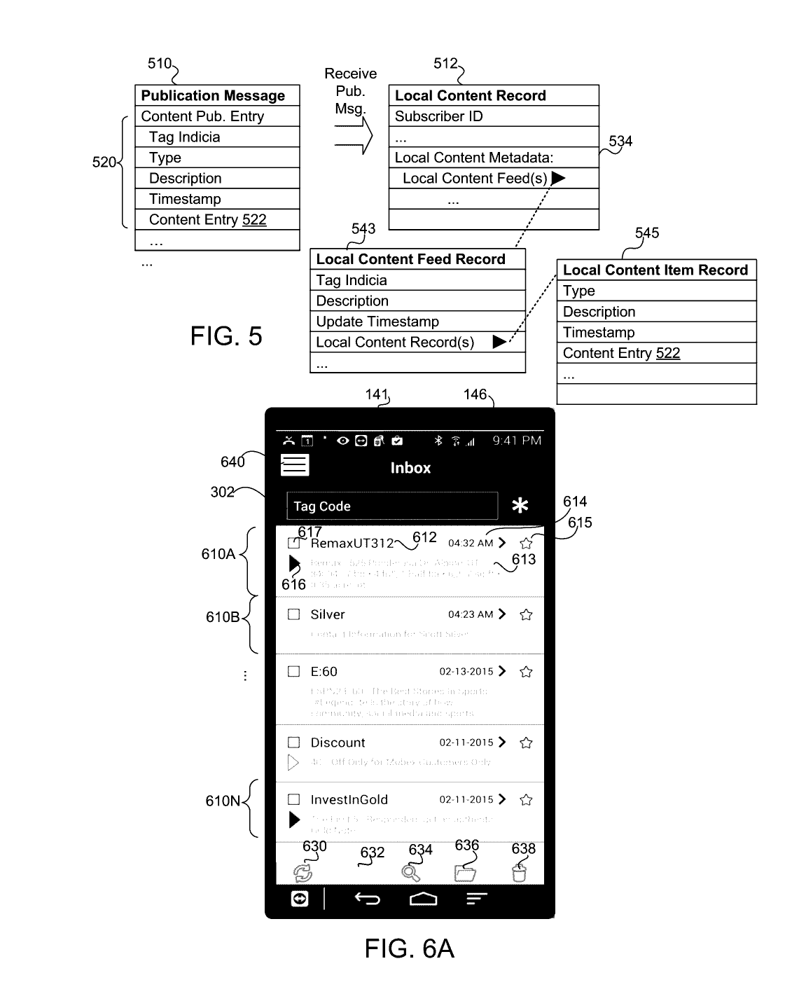

Referring to FIG. 5, the publication engine 116 may publish a content item by, inter alia, transmitting a publication message 510 to the client application 140 through the network 105. The publication message 510 may comprise one or more content publication entries 520. A content publication entry 520 may correspond to one or more content item records 215 of a particular content feed record 213. A content publication entry 520 may include a content entry 522. A content entry 522 may comprise a content item, which may include but is not limited to: text content, image content, audio content, video content, multimedia content, executable code, renderable content, markup content (e.g., HTML content), structured content (e.g., XML content), unstructured content, and/or the like. Alternatively, or in addition, the content entry 522 may reference content hosted by the content distribution service 110, publisher 130, content host 132, and/or other network-accessible service. Accordingly, in some embodiments, the content entry 522 comprises one or more links to hosted content (e.g., one or more URLs). The content publication entry 520 may further include, but is not limited to: tag indicia (and/or another identifier) that specifies the tag and/or content feed associated with the content entry 522, a content type indicator, a description of the content of the content publication entry 520 (e.g., description of the corresponding content item record 215), a timestamp indicating a publication time of the content (e.g., the time that the publication message 510 was transmitted and/or the time the corresponding content item records 215 were published to the content distribution service 110), and so on. In some embodiments, the publication message 510 may further include an authentication credential to enable authentication of the source of the publication message 510 and/or integrity of the data included in the publication message 510. Alternatively, or in addition, the publication message 510 may be communicated through a secure communications channel such as a Secure Sockets Layer (SSL) connection. Although a particular embodiment of a publication message 510 is described herein, the disclosure is not limited in this regard and could be adapted to publish content using any suitable data format and/or communication mechanism.

As disclosed herein, the publication engine 116 may transmit publication messages 510 to the client application 140 in response to a) subscription requests 310, publication requests 330, and/or other events. In response to receiving a publication message 510, the content manager 148 of the client application 140 may record the content entry in storage of the client device 141. The content manager 148 may be configured to maintain an “inbox” comprising tags, content feeds, and/or content items published to the client application 140 by the content distribution service 110. In the FIG. 5 embodiment, the content manager 148 is configured to record content in a local content record 512 stored on non-transitory storage of the client device 141. The local content record 512 may include subscription information as disclosed above in conjunction with the local subscriptions record 434 of FIG. 4. Accordingly, in some embodiments, the local content record 512 comprises a subscriber identifier 312 and/or other information pertaining to a user 143 of the client application 140. Alternatively, the local content record 512 may not include and/or be derived from identifying information pertaining to the user 143.

The local content record 512 may comprise local content metadata 534, which may comprise references to one or more local content feed(s) (e.g., references to local content feed records 543). A local content feed record 543 may comprise information regarding content corresponding to particular tags (e.g., content of particular content feeds). As depicted in FIG. 5, a local content feed record 543 may include, but is not limited to: tag indicia corresponding to the particular content feed, a description of the content feed, an update timestamp indicating a last update time of the particular tag and/or content feed, and/or references to one or more local content item records 545. A local content item record 545 may correspond to a particular content item published to a particular tag and/or content feed. A local content item record 545 may include, but is not limited to: a content item type, a description of the content item, a timestamp indicating the time the content item was received at the client device 141 and/or was published to the content distribution service 110, a content entry 522, and so on. The content entry 522 may correspond to the content entry 522 of a publication message 510. Accordingly, the content entry 522 may comprise a content item (e.g., text, audio, video, multimedia, markup, etc.) and/or may reference content hosted on a network-accessible service.

The content manager 148 of the client application 140 may update one or more of the local content record 512, a local content feed record 543, and/or a local content item record 545 in response to a publication messages 510 from the content distribution service 110. In response to receiving a publication message 510, the content manager 148 may be configured to identify a local content feed record 543 corresponding thereto by, inter alia, comparing tag indicia of a content publication entry 520 of the publication message 510 to tag indicia of one or more local content feed records 543 stored on the client device 141. If no local content feed record 543 for the tag indicia is found, the content manager 148 may create a new local content feed record 543, and include a reference thereto in the local content record 512. The content manager 148 may be further configured to create a local content item record 545 corresponding to the content entry 522 of the publication message 510 and to associate the local content item record 545 with the identified local content feed record 543. The contents of the local content item record 545 may correspond to and/or be derived from the contents of the content publication entry 520, as disclosed herein.

Although particular embodiments of records for managing content distribution are described herein, the disclosure is not limited in this regard and could be adapted to record information related to tags, content feeds, content items, and related metadata using any suitable data storage format and/or technique.

The client application 140 may be configured to display content feeds on the mobile computing device 141 by use of, inter alia, the content interface 146. In some embodiments, the content interface 146 is configured to display content recorded in one or more of the local content record 512, local content feed record(s) 543, and/or local content item record(s) 545, as disclosed herein.

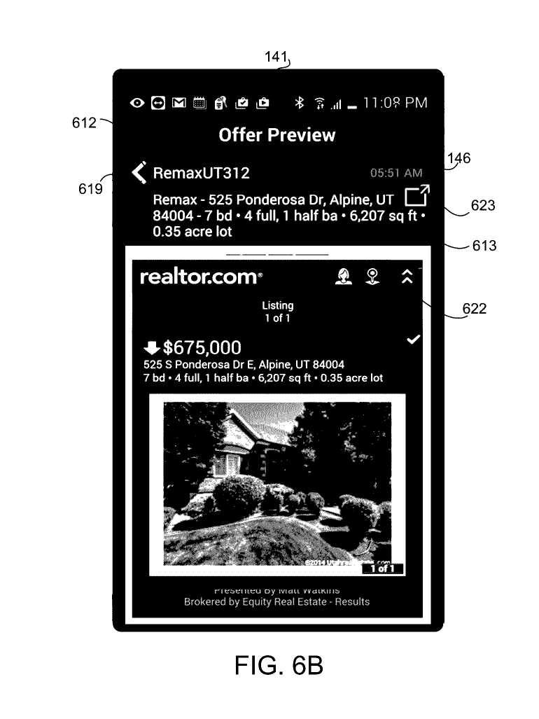

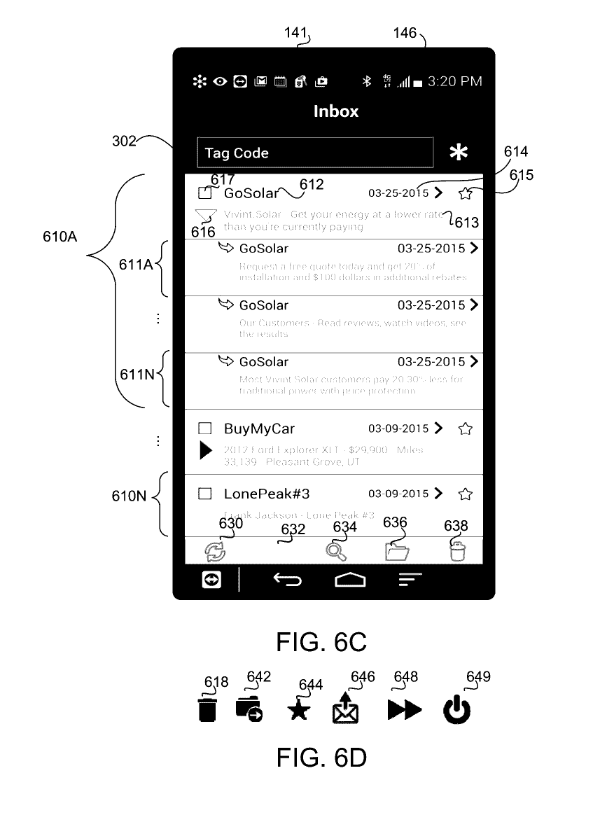

FIG. 6A depicts one embodiment of a content interface 146 of the client application 140. In the FIG. 6A embodiment, the client application 140 has subscribed to a plurality of content feeds (recorded as respective local content feed records 543), and the content interface 146 may be configured to display information pertaining to the plurality of content feeds. In some embodiments, the content interface 146 displays information pertaining to content feeds in a threaded manner. The content interface 146 may be configured to represent a content feed (e.g., a local content feed record 543) as respective content feed entries 610A-N. The content feed entries 610A-N may display information pertaining to respective content feeds, which may include, but is not limited to: a name 612 of the content feed (e.g., tag indicia associated with the content feed), a description 613 of the content feed, a time and/or date indicator 614 of the time and/or date the subscription was established, a “favorite” input 615, an expand input 616, a selection input 617, and so on. The favorite input 615 may be used to designate favorite content feeds. In some embodiments, content feed entries 610A-N that are identified as favorites are highlighted within the content interface 146 (e.g., may be displayed in a bold font, may comprise graphical annotations, may be ordered before other content feeds, and/or the like). The selection input 617 may be used to select a particular content feed entry 610A-N for particular selection and/or management operations, as described in further detail herein. The content interface 146 may further include a refresh input 630, a filter input 632, a search input 634, a folder management input 636, and a delete/unsubscribe input 638, a menu 640, and so on.

In response to selection of a content feed entry 610A-N, the content interface 146 may invoke a display of a corresponding content item in the content interface 146, as depicted in FIG. 6B. In the FIG. 6B embodiment, the content feed entry 610A has been selected (tag “RemaxUT312”). In response, the content display 146 is configured to display the content feed name 612, description 613, a return link 619 to access the content feed display of FIG. 6A, and a content item 622. The content item 622 of FIG. 6B comprises a markup content item (e.g., HTML content). The content interface 146 may further include an external viewer input 623. In response to selection of the external viewer input 623, the client application 140 may launch an external viewer, such as a web browser, image viewer, video player, and/or the like. The external viewer input 623 may, for example, be used to directly access content hosted by a publisher 130, content host 132, and/or other source.

Referring to FIG. 6C, in some embodiments, a content feed may comprise a plurality of content items (e.g., a local content feed record 543 may reference a plurality of local content item records 545). As disclosed above, the content interface 146 may be configured to display content feed entries 610A-N in a threaded format. In the FIG. 6C embodiment, the expand input 616 of the content feed entries 610A-N indicates whether a content feed comprises more than one content item. As illustrated in FIG. 6C, in response to selection of an expand input 616 of the content entry 610A, the content interface 146 may be configured to display separate content item entries 611A-N corresponding to the corresponding tag. Each of the content item entries 611A-N may comprise information pertaining to a respective content item (e.g., a respective local content item record 545). The content item entries 611A-N may include a description of a content item, the date the content item was published, and so on, as disclosed herein. In response to selection of a content item entry 611A-N, the content interface 146 may invoke a display of the corresponding content item, as described above in conjunction with FIG. 6B.

As disclosed above, the content interface 146 may comprise inputs for managing content tag and/or content feed subscriptions displayed therein. In the FIG. 6C embodiment, the content interface comprises a refresh input 630, a filter input 632, a search input 634, a folder management input 636, and a delete-unsubscribe input 638.

A user may unsubscribe from a tag and/or content feed by a) selecting the selection input 617 of the content feed entry 610A-N and b) selecting the delete/unsubscribe input 638 or the off input 649. Unsubscribing from a tag may comprise removing content pertaining to the tag (and/or corresponding content feed) from the client application 140 (e.g., deleting the content from the client device 141 by, inter alia, removing the corresponding local content feed record 543 and/or local content item records 545 referenced thereby). Unsubscribing may further comprise transmitting an unsubscribe request to the content distribution service 110. The unsubscribe request may comprise a subscriber identifier 312 and tag indicia of the selected content feeds. In response, the subscription manger 114 may be configured to remove subscription(s) to the content feeds in the corresponding subscriber record 412. Alternatively, or in addition, unsubscribing may comprise updating subscription information maintained on the mobile computing device 141, as disclosed herein (e.g., updating a local subscriptions record 434 and/or a local content record 512, disclosed in further detail below).

In response to selection of the refresh input 630, the content interface 146 may refresh the content feed entries 610A-N and/or content item entries 611A-N displayed therein. In response to selection of the refresh input 630, the content manager 148 may be configured to transmit a content request 330 to the content distribution service 110 through the network 105. The content request 330 may comprise content feed identifier(s) (e.g., tag indicia) corresponding to a set of content feeds. The set of content feeds may correspond to the content feed(s) to which the client application 140 is subscribed. Alternatively, the set may include content feed(s) that are currently being displayed in the content interface 146 and/or content feed(s) having a selection input 617. The content request 330 may comprise a timestamp 316 indicating the last update time of the set of content feeds (as specified in the corresponding local content feed records 543). In response to the content request 330, the publication engine 116 of the content distribution service 110 may identify updated content items for the specified content feeds (e.g., based on the provided timestamp(s) 316), and may publish the updated content items to the client application 140, as disclosed herein (e.g., by transmitting one or more publication messages 510 to the client application 140 corresponding to the identified content item records 215).

In response to selection of the filter input 632, the content interface 146 may be configured to filter the content feed entries 610A-N and/or content item entries 611A-N based on one or more filter criteria, such as keywords, publication dates, and/or the like. The filter criteria may be specified by use of a text tag input 302 of the content interface 146. In response to selection of the search input 634, the content interface 146 may search for particular content feed entries 610A-N and/or content item entries 611A-N based on one or more search criteria, such as keywords, publication dates, and/or the like. The folder management input 636 may be configured to provide for categorizing one or more content feed entries 610A-N and/or content item entries 611A-N into respective groups (e.g., folders and/or other grouping mechanism). Although a particular set of inputs and/or controls of the content interface 146 are described herein, the disclosure is not limited in this regard and could be adapted to incorporate any set of suitable inputs and/or controls. FIG. 6D depicts further embodiments of input and/or controls of the content interface 146. The inputs and/or controls of FIG. 6D could be embodied as a toolbar of the content interface 146. As illustrated in FIG. 6D, the content interface 146 may include a delete input 638 to unsubscribe/delete one or more content feed entries 610A-N, as disclosed herein. As used herein, deleting a content feed entry 610A-N may comprise a) deleting content items of the content feed entry 610A-N from the mobile computing device 141, and b) recording that the content feed is no longer subscribed (e.g., removing the content feed from a local subscriptions record 434, and/or the like). A move input 642 may be used to move a content feed entry 610A-N and/or content item entry 611A-N into one or more category groups (e.g., folders). A favorite input 644 may be used to designate one or more of content feed entries 610A-N and/or content item entries 611A-N as a favorite based on the status of the respective selection inputs 617 thereof. An extract input 646 may be used to extract one or more content feeds and/or content items to an external communication channel and/or storage location, such as an email address, shared storage (e.g., cloud-based storage), and/or the like. In response to selection of the extract input 646, the client application 140 may transmit selected content feeds and/or content items to one or more communication channels and/or storage locations. The content feeds and/or content items may be designated by use of respective selection inputs 617, as disclosed herein. A forward input 648 may be configured to forward one or more content feeds and/or content items to another communication channel, such as email, text messaging, instant messaging, social media, and/or the like. In response to selection of the forward input 648, the client application 140 may transmit selected content feeds and/or content items to one or more user-specified recipients. The content feeds and/or content items may be designated by use of respective selection inputs 617, as disclosed herein. A deactivate input 649 may be used to deactivate updates to one or more content feed(s) (as specified by selection of respective selection inputs 617 of the content feed entries 610A-N). In response to selection of the deactivate input 649, the client application 140 may record that the selected content feeds are no longer to be updated (are unsubscribed), which may comprise transmitting an unsubscribe message to the content distribution service 110, updating a local subscriptions record 434, and/or the like. The client application 140 may retain content items stored on the client device 141, such that the content feed entries 610A-N and content item entries 611A-N remain available through the client application 140 (e.g., retain the local content feed records 543 and/or local content item records 545 of the deactivated content feed).

As disclosed above, the client interface 146 may comprise a refresh input 630 to cause the client application 140 to issue one or more content requests 330 to the content distribution service 110. Alternatively, or in addition, the client application 140 may be configured to automatically request updated content updates from the content distribution service 110. In some embodiments, the content manager 148 is configured to transmit content requests 330 to the content distribution service 110 at a particular interval or time period. The content requests 330 may comprise tag indicia 314 of the content feed(s) to which the client application 140 is subscribed (e.g., based on a local subscriptions record 434 and/or local content record 512 stored on the client device 141). Alternatively, or in addition, the content requests 330 may comprise a subscriber identifier 312 that corresponds to a subscriber record 412 maintained on the non-transitory store 113 of the content distribution service 110. In response to a content request 330, the publication engine 116 may determine whether any new content items (and/or modified content items) are available for the specified content feed(s). The publication engine 116 may identify new and/or modified content items based on a timestamp 316 of the content request 310 (and/or respective timestamps corresponding to each of a plurality of tags and/or content feeds). In response to the content request 330, the publication engine 116 may return content items published and/or modified after the time indicated in the timestamp 316 by, inter alia, transmitting one or more publication messages 510 to the client device 140. The content manager 148 may update the local content record 512, local content feed record(s) 543, and/or local content item record(s) 545 in response to the publication messages 510, as disclosed herein. The content interface 146 may be configured to refresh the display of the client device 141 to show new content received in the publication messages 510 (if any), by, inter alia, re-reading the updated local content record 512, local content feed record(s) 543, and/or local content item record(s) 545 stored on the client device 141.

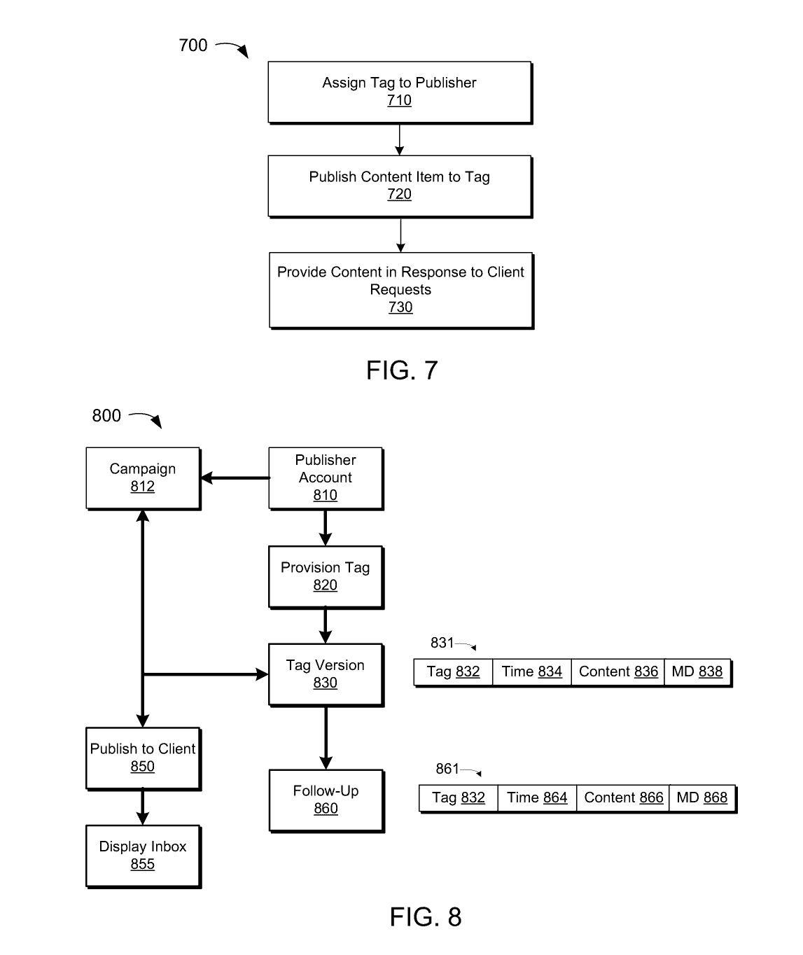

Referring to FIG. 1, a publisher 130 may establish an account with the content distribution service 110 in order to, inter alia, publish content items to one or more tags and/or content feeds managed thereby. FIG. 7 is a flow diagram of one embodiment of a method 700 for publishing content to the content distribution service 110 disclosed herein. Step 710 may comprise assigning a tag to a publisher 130. Step 710 may comprise creating a tag at the content distribution service 110 (e.g., by use of the tag manager 112). Creating a tag at step 710 may comprise establishing a publisher account for the publisher 130 by, inter alia, recording publisher account information on the non-transitory store 113 by use of the registration module 118. The publisher account information may include a publisher name, publisher contact information, payment information, authentication credentials, users authorized to act for the publisher, and so on. Step 710 may further comprise validating the registration information of the publisher 130 by, inter alia, sending a verification message to the publisher 130 by use of one or more communication channels (e.g., an email, text message, and/or the like). Step 710 may further comprise assigning one or more tags to the publisher 130. Step 710 may comprise receiving a request to provision a tag to the publisher 130. The request may comprise tag indicia, a validity date range, a content item (and/or link to a content item), and so on.

Step 720 may comprise publishing content to the tag of step 710. Step 720 may comprise receiving a request to publish a content item to the tag from the publisher 130 and/or an authorized user. The content item (and/or link to the content item) may be included with the request to provision the tag to the publisher 130 of step 710. Alternatively, the request of step 720 may comprise a separate request that is received after the publisher 130 has registered an account with the content distribution service 110, and provisioned the tag at step 710. Step 720 may comprise receiving a content item to be hosted by the content distribution service 110, a link to a content item hosted by the publisher 130, content host 132, or other network-accessible service (e.g., a web page), and/or the like. Step 720 may further comprise associating the content item with the tag of step 710. Accordingly, step 720 may comprise associating specific digital content with tag indicia.

Step 730 may comprise publishing content to users 143 in response to requests from client applications 140 (a client request). The requests may comprise the tag indicia of step 710. The requests may be generated and/or issued by a subscription interface 144 of a client application 140, as disclosed herein. Step 730 may comprise returning the content item(s) associated with the provided tag indicia. Step 730 may further comprise displaying the content item in a content interface 146, as disclosed herein.

FIG. 8 depicts further embodiments of operations and/or data relationships 800 for content distribution as disclosed herein. The publisher account record 810 corresponds to a particular publisher (e.g., publisher 130) that has registered an account with the content distribution service 110, as disclosed herein. The publisher 130 may define a campaign 812 that comprises one or more tags. The tags of the campaign 812 may correspond to different tag indicia (e.g., different tag words, phrases, and/or the like). Alternatively, the campaign 812 may comprise tags having the same indicia, with different validity dates, content items, regions (e.g., locale), language, and/or the like. The content distribution service 110 may persist information pertaining to the publisher account 810 and/or campaign 812 on non-transitory store 113, as disclosed herein.

The publisher 130 may provision a tag managed by the content distribution service 820. As disclosed herein, provisioning a tag may comprise assigning tag indicia to the particular publisher 130, such that the publisher 130 is authorized to publish content item(s) to the tag. Publishing a content item of a particular tag may comprise creating a tag version 830. The tag version 830 may comprise a unique combination of the tag indicia of 820, a content item (e.g., a web page), and/or a date range during which the tag is active and available for distribution to users 143. The publisher 130 may establish a plurality of different tag versions 830 (e.g., campaigns 812) pertaining to the same tag indicia. The tag versions 830 may be active at different times, pertain to different locales, and/or the like.

In some embodiments, creating a tag version of 830 may comprise creating one or more of a tag record 212, content feed record 213, and/or content item record 215. Alternatively, creating a tag version 830 may comprise a unique combination of the tag indicia, publication date rage, and so on, as disclosed above. Creating a tag version 830 may comprise creating a tag version record 831 that comprises a unique combination of a tag 832 (e.g., tag indicia), a publication time 834 (e.g., a date range during which the tag is available), content 836, and so on. In some embodiments, the tag version record 831 further includes metadata 838, which may comprise one or more of: metrics pertaining to the tag (e.g., number of subscriptions, subscriber demographics, subscription times, response rate, and so on), a link to a particular campaign 812, a link to a particular publisher 130, tag management metadata, such as whether the tag is currently active and/or enabled, location constraints, and so on.

As disclosed above, the content distribution service 110 may publish content to clients (publish to client 850) in response to client requests. A client may request content of a particular tag by, inter alia, manipulating a subscription interface 144 and/or content interface 146 of the client application 140, to cause the client application 140 to transmit a subscription and/or content request to the content distribution service 110. In response, the content distribution service 110 may identify the tag version 830 corresponding to the request (e.g., based on tag indicia of the request, request date, request locale, and/or the like), and provide content to the client application 140. The content published to the client application 140 may include a content item and corresponding metadata, such as a description, name, identifier (e.g., TID), and/or the like. The client manager 148 may record the content item and corresponding metadata, such as the TID, on non-transitory store of the client device 141 (e.g., in a local content record 512). An entry corresponding to the tag and/or content may be presented on the client device 141 by use of the content interface 146. The entry and/or corresponding content may be displayed in an inbox 855 of the client application 140. In some embodiments, the publication engine 116 is configured to select content for publication by, inter alia, referencing tag records 212 stored on the non-transitory storage 113 of the content distribution service. The publication engine 116 may be further configured to identify a content feed record 213 corresponding to a particular tag, and select one or more content item records to publish, as disclosed herein. Alternatively, the publication engine 116 may be configured to select a tag version record 831. The publication engine 116 may select content by, inter alia, matching tag indicia to an entry in the tag records 212 and/or tag version record 831, matching a time of the request with a validity timeframe of the corresponding content item record(s) 215 and/or tag version record 831, and so on.

The publisher 130 may publish additional content to particular tag versions 830 (e.g., follow-up content 860). Follow-up content 860 may comprise content related to a particular tag and/or campaign 812. Publishing follow-up content 860 may comprise receiving a request to publish follow-up content from the publisher 130 (e.g., a content item), writing the follow-up content 860 on non-transitory store 113, and publishing the follow-up content 860 to client applications 140 that have subscribed to the corresponding tag and/or tag version 830. The follow-up content 860 may be pushed to a client application 140 and/or provided in response to a content request 330, as disclosed herein. The client application 140 may display the follow-up content 860 in the inbox 855, as disclosed herein. In some embodiments, publishing follow-up content comprises creating one or more content item record(s) 215 of a content feed record 213. Alternatively, or in addition, publishing follow-up content may comprise creating a follow-up content record 861 that includes, inter alia, a tag 832 (e.g., tag indicia) and/or a reference to a tag version record 831, a publication time 866 (e.g., a date range during which the folllow-up content is published and/or available), content 866, metadata 868, and so on. The follow-up content record 861 may be maintained on the non-transitory store 113 of the content distribution service 110.

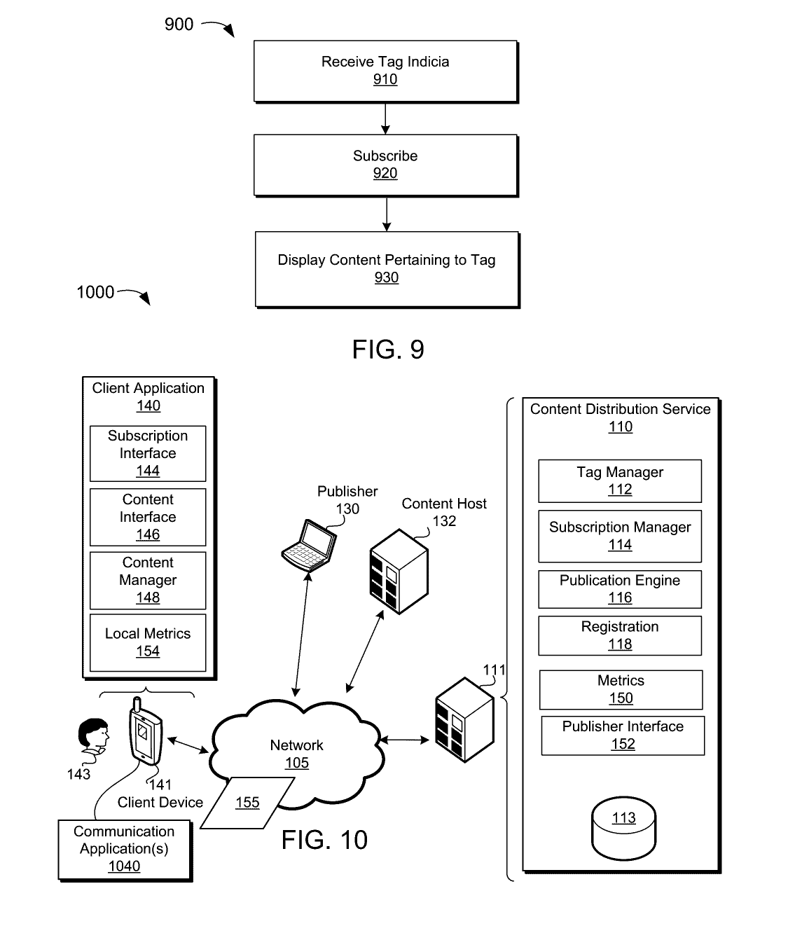

FIG. 9 is a flow diagram of another embodiment of a method 900 for distributing content. Step 910 may comprise receiving tag indicia from a user. Step 910 may comprise receiving tag indicia through, inter alia, a subscription interface 144 of a client application 140. Accordingly, in some embodiments, step 910 includes installing the client application 140 on a client device 141. Step 910 may further include registering a user account with the content distribution service 110. Registering a user account may comprise providing user information such as name, gender, age, contact information, and so on. Alternatively, the user may access the content distribution service 110 anonymously, without providing user-identifying information. In some embodiments, registering a user account may comprise providing general preference and/or demographic information that does not include any personally identifying information (e.g., gender, age, profession, and so on).

As disclosed above, the tag indicia of step 910 may be received through a subscription interface 144 of the client application 140. The tag indicia may be received in response to interaction with the client device 141. In some embodiments, the user 143 of the mobile device 141 provides tag indicia in response to a prompt, such as a “call to action” in adverting content. As disclosed above, the subscription interface 144 may provide a simple and efficient mechanism for indicating interest in particular content for follow-up at a later time. In some embodiments, the subscription interface 144 comprises a text input (e.g., input 302 of FIG. 3) through which a user 143 may enter tag indicia. Alternatively, or in addition, step 910 comprises receiving an audio prompt, such as a voice activated command (through the audio input 304 of FIG. 3). Step 910 may, therefore comprise receiving a voice activated command to subscribe to a particular tag. In another embodiment, step 910 may comprise receiving tag indicia as an image and/or video (through an image input 306 of FIG. 3). Step 910 may comprise extracting text tag indicia from the image and/or video content. Alternatively, step 910 may comprise using the audio, image, and/or video content as tag indicia.

Step 920 may comprise subscribing to a tag, content feed, and/or campaign in response to receiving the tag indicia of step 910. Step 920 may comprise one or more of a) transmitting a subscription request 310 to the content distribution service 110, b) transmitting a content request 330 to the content distribution service 110, and/or c) recording the subscription on non-transitory store 113 of the client device 141 (e.g., in a local subscriptions record 434). The subscription request 310 and/or content request 330 transmitted to the content distribution service 110 may comprise an identifier of the user (e.g., user account information), a generic identifier, the tag indicia of step 910, and so on, as disclosed herein. Step 920 may further comprise receiving a response from the content distribution service 110 to one or more of the subscription request 310 and/or content request 330. The response may include a tag identifier (e.g., a reference to a specific tag record 212 maintained by the tag manager 112), content published to the tag, and so on, which may be recorded on the mobile device 141 within, inter alia, a local content record 512, local content feed record 543, local content item record 545, and/or the like, as disclosed herein. Accordingly, step 920 may comprise recording content pertaining to the tag indicia on the client device 141 for access by the user 143 at a later time.

Step 930 may comprise displaying content pertaining to the tag indicia of step 910 on the mobile device 141. Step 930 may comprise presenting one or more content feeds and/or content items by use of the content interface 146. As disclosed above, the content interface 146 may be configured to display an inbox comprising tags to which the user 143 has subscribed. The tag subscriptions may be presented as respective content feed entries 610A-N, as illustrated in FIGS. 6A and 6C. Information pertaining to content items published to the respective tags may be displayed as content item entries 611A-N. Step 930 may further comprise displaying a particular content item published to a tag, as illustrated in FIG. 6B.

FIG. 10 is a schematic block diagram of another embodiment of a system 1000 for content distribution. As depicted in FIG. 10, the client device 141 may comprise one or more communication application(s) 1040 that correspond to respective, general-purpose communication channels, which may include but are not limited to: email, text messaging, instant messaging, voice calling, and/or the like. The communication application(s) 1040 may be separate from the client application 140, such that the communication channel of the client application 140 (e.g., the communication channel between the client device 141 and the content distribution service 110) is separate from and/or independent of the other communication application(s) 1040 on the client device 141. The client application 140 may be configured to establish a communication channel with the content distribution service 110 without personally identifying information pertaining to the communication application(s) 1040, such as name, email address, device identifier, carrier identifier, phone number, text identifier, and/or the like. Accordingly, the user 143 may utilize the client application 140 without risk of exposing the communication application(s) 1040 to unwanted messaging and without risk of exposure of contact information of the user 143 on the corresponding, general-purpose communication channels.

In the FIG. 10 embodiment, the content distribution service 110 may further comprise a metrics module 150 and publisher interface 152. The metrics module 150 may be configured to determine metrics corresponding to particular tags, campaigns, content feeds, publishers, and/or the like. The publisher interface 152 may be configured to provide interface(s) for managing tags, content, campaigns, and/or content feeds of a publisher 130, viewing metrics pertaining to the publisher 130, and so on.

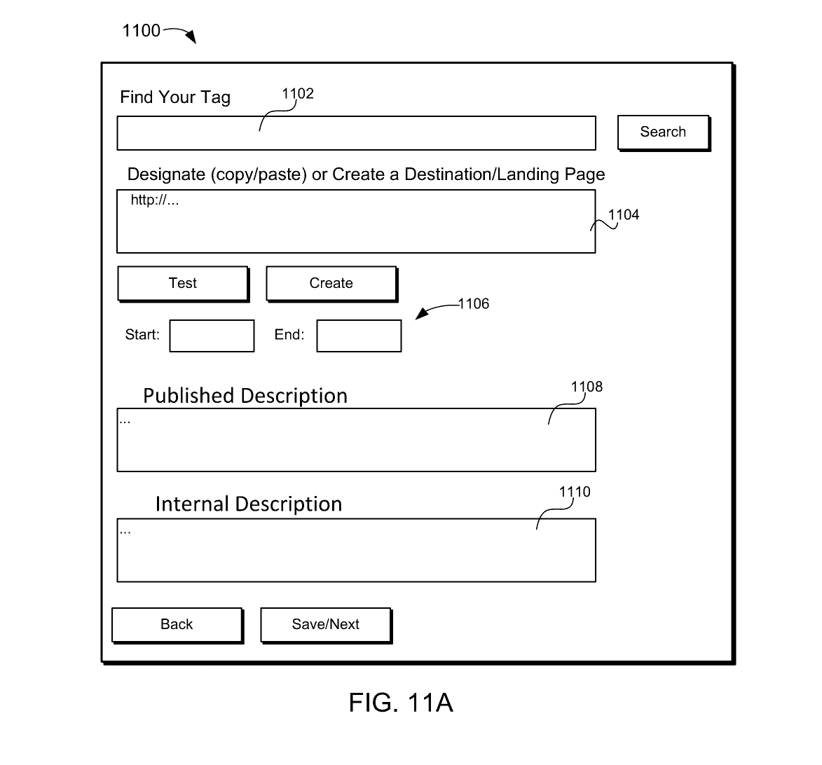

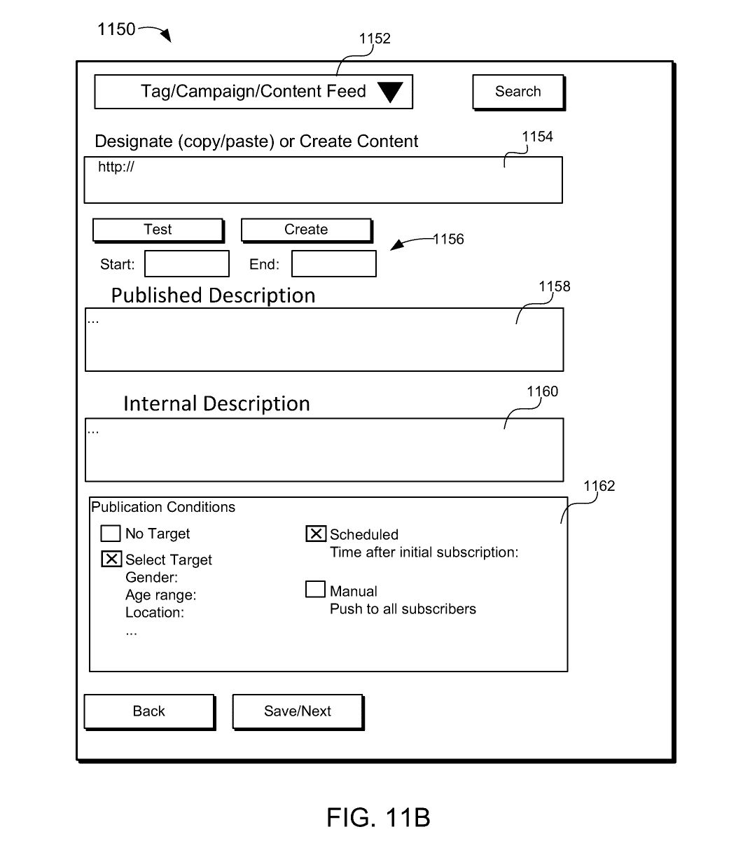

FIG. 11A depicts one embodiment of an interface 1100 of the publisher interface 152 for, inter alia, provisioning a tag to a publisher 130 and/or publishing content to a tag. The interface 1100 may include a tag indicia input 1102. A publisher 130 may enter desired tag indicia into the input 1102 and/or perform a search to determine whether a desired tag is available (not already assigned to another publisher) and/or has already been provisioned to the particular publisher 130. Although the interface 1100 illustrates a tag indicia input 1102 for text input, the disclosure is not limited in this regard, and could be adapted for use with any suitable input type, such as an audio input, image input, video input, and/or the like. The interface 1100 may further include a content input 1104 to publish an initial content item to the tag (a “destination/landing page” for the tag). In the FIG. 11A embodiment, the publisher 130 is prompted to enter a link to a network-accessible resource (e.g., a URL). Alternatively, or in addition, a publisher 130 may enter markup (and/or other content) to publish to the tag. The interface 1100 may further include a test input to test the provided content item. Selecting the test input may invoke a viewer application (e.g., a web browser) directed to the URL and/or other content referenced in the content input 1104. The test input may invoke and/or emulate a content display interface, as depicted in FIGS. 6A and/or 6B. The create input may invoke an editor for authoring a content item (e.g., an HTML editor). A date range input 1106 may be used to specify publication date(s) for the tag and corresponding content. A published description input 1108 may be used to provide a description of the tag and/or content item (e.g., a description of the corresponding tag record 212 and/or or content feed record 213). The contents of the published description input 1108 may be displayed by the content interface 146 of the client application 140 (as the description 613 illustrated in FIGS. 6A and 6B). An internal description input 1110 may be used to provide an internal, non-published description of the tag and/or content item, which may be stored in the tag record 212 (e.g., as tag metadata), and/or the like.

The information provided in the interface 1100 may be recorded in one or more of a content feed record 213 and/or content item record 215 on the non-transitory store 113 of the content distribution service 110. The publication engine 116 of the content distribution service 110 may access the recorded information in order to, inter alia, respond to subscription requests 310, respond to content requests 330, push content to client application(s) 140, and so on, as disclosed herein.

The publisher interface 152 may further comprise interface(s) for publishing follow-up content to a tag, campaign, and/or content feed. FIG. 11B depicts one embodiment of an interface 1150 for publishing follow-up content. The interface 1150 may comprise a selection input 1152 for specifying a particular tag, campaign, and/or content feed. Alternatively, or in addition, the selection input 1152 may comprise a search input to search for a particular tag, campaign, and/or content feed assigned to the publisher 130. The interface 1150 may further include a content input 1154 for designating and/or creating the follow-up content item, a date range input 1156 for specifying a publication date range, a description input 1158, and internal description input 1160, as disclosed herein.

The interface 1150 may further include a publication conditions input 1162 for specifying conditions under which the follow-up content is to be published to particular subscribers. The publication conditions input 1162 may provide for designating target demographics based on one or more of gender, age range, location, and/or the like. Alternatively, the follow-up content may be designated for publication to all subscribers regardless of demographics (e.g., no target). The publication conditions input 1162 may further include input elements for specifying a publication schedule. As illustrated in FIG. 11B, a follow-up content item may be scheduled to publish to a client at a pre-determined time after initial subscription by the client (e.g., scheduled). Alternatively, a follow-up content item may be published to clients manually (e.g., may publish to subscribers at a particular time, regardless of the time elapsed since subscription).

The information provided in the interface 1150 may be recorded in one or more of a content feed record 213 and/or content item record 215 on the non-transitory store 113 of the content distribution service 110. The publication engine 116 of the content distribution service 110 may access the recorded information in order to, inter alia, respond to subscription requests 310, respond to content requests 330, push content to client application(s) 140, and so on, as disclosed herein.

Referring back to FIG. 10, the metrics module 150 of the content distribution service 110 may be configured to track metrics pertaining to tags, content items, campaigns, content feeds, and/or particular publishers 130. Such metrics may include, but are not limited to: the number of subscribers to particular tags and/or subscribers to tags of a particular publisher 130 and/or campaign; the characteristics of the subscribers to particular tags, campaigns, and/or content feeds; the view rate of particular tags, content items, and/or campaigns (e.g., whether the content of a particular tag and/or campaign has been displayed to a user 143); the delete rate of particular tags, content items, and/or campaigns; the metrics pertaining to follow-up content published to particular tags, campaigns, and/or content feeds; and/or the like.

In some embodiments, the metrics module 150 derives metrics from messages received at the content distribution service 110. The metrics module 150 may track subscriptions to tags based on subscription requests 310, content requests 330, unsubscribe requests, and so on received at the content distribution service 110. Alternatively, or in addition, the metrics module 150 may access information pertaining to the metrics tracked thereby from a client application 140 (by use of a local metrics module 154).

As illustrated in FIG. 10, the client application 140 may comprise a local metrics module 154 configured to, inter alia, track metrics pertaining to the client application 140. The metrics tracked by the metrics module 154 may include, but are not limited to: tag searches (entered through the subscription interface 144), tag subscriptions, metrics pertaining to particular content feeds (e.g., selection of particular content feed entries 610A-N in the content interface 146), metrics pertaining to particular content items (e.g., selection of a particular content feed entry 610A-N and/or content item entry 611A-N, as depicted in FIGS. 6A and 6C, display of particular content items as depicted in FIG. 6B, and so on), metrics pertaining to unsubscribe requests, metrics pertaining to deactivation requests, metrics pertaining to designation of favorites, and so on.

The local metrics module 154 may record local metrics tracked thereby on non-transitory store 113 of the client device 141 (e.g., in a local metrics record and/or other data structure). The client application 140 may be configured to include information pertaining to the local metrics tracked by the local metrics module 154 in messages transmitted to the content distribution service 110 (e.g., in subscription requests 310, content requests 330, and so on). Alternatively, or in addition, the local metrics module 154 may be configured to send information pertaining to the local metrics gathered thereby in separate reporting messages 155. In some embodiments, the metrics module 150 requests reporting messages 155 from client applications 140. In other embodiments, the client applications 140 may be configured to periodically transmit reporting messages 155 to the content distribution service 110.

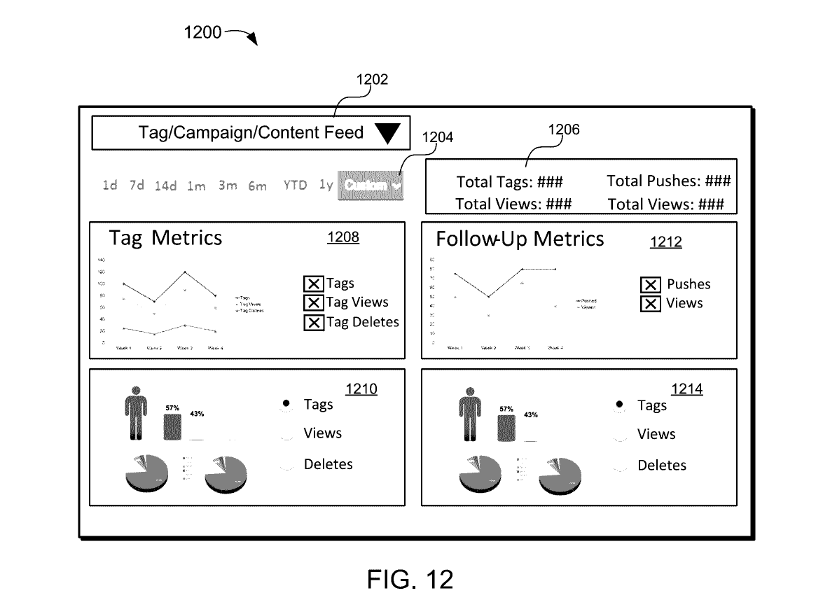

The metrics module 150 of the content distribution service 110 may aggregate metrics received from the client applications 140 and derive publisher metrics 153 therefrom. The publisher metrics 153 may be stored on non-transitory store 113 of the content distribution service 110. As disclosed above, the publisher metrics 153 may comprise information pertaining to tags, campaigns, content feeds, and/or content items of a particular publisher 130. Publisher metrics 153 may further include user demographic information (if available). The publisher interface 152 may provide interface(s) for accessing publisher metrics 153. FIG. 12 depicts one embodiment of an interface 1200 for displaying publisher metrics 153, as disclosed herein. The interface 1200 may include a selection control 1202 to specify a particular tag, campaign, and/or content feed of the publisher 130 (e.g., display metrics related to the “pizza” tag). A date control 1204 may specify a particular time range. The publisher metrics 153 displayed in the interface 1200 may be filtered based on the selected tag, campaign, and/or content feed (specified in selection control 1202) and the date range of the date control 1204.

The tag statistics display area 1206 may be configured to display statistics regarding the selected tag, campaign, and/or content feed during the designated date range, such as the total number of tag subscriptions (“total tags”), total tag views, total pushes (e.g., number of times content was provided to a particular client application 140), total views of content, and so on. The tag metrics display area 1208 may comprise a graphical representation of one or more tag metrics, such as the number of tag subscriptions, tag views, and/or tag deletes within the selected date range. The follow-up metrics display area 1212 may be configured to display metrics pertaining to follow-up content published to the selected tag, campaign, and/or content feed. As disclosed above, a follow-up content item may refer to a content item that is published after the initial (“landing page”) content item. The follow-up metrics display area 1212 may indicate the number of follow-up items that were published to the particular tag, campaign, and/or content feed and/or view statistics regarding the follow-up content items. The tag metrics demographic display 1210 may comprise demographic metrics corresponding to the tag metrics display area 1208, and the follow-up metrics demographic display 1214 may comprise demographic metrics corresponding to the follow-up metrics display area 1212.

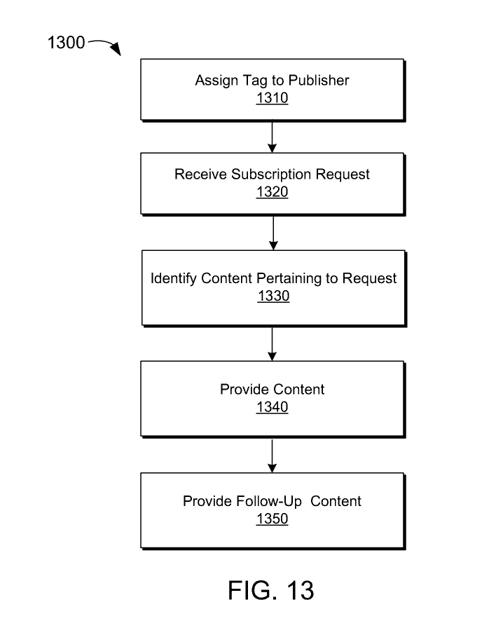

FIG. 13 is a flow diagram of another embodiment of a method 1300 for content distribution. Step 1310 may comprise assigning a tag to a publisher 130, as disclosed herein. Step 1310 may include publishing content to the tag in response to a publication message 510 and/or through the publisher interface 152 (e.g., thorough one or more of the interfaces 1100 and/or 1150 of FIGS. 11A and/or 11B, as disclosed above). Step 1320 may comprise receiving a request to subscribe to the tag from a user 143 (through the client application 140). Step 1320 may comprise receiving a subscription request 310, a content request 330, and/or the like. Step 1330 may comprise identifying content pertaining to the request by, inter alia, comparing tag indicia and/or a TID of the request to identify a tag record 212 maintained by the tag manager 112. Step 1330 may further comprise accessing a content feed record 213 and/or content item record 215 of the identified tag record 212. Step 1340 may comprise providing content pertaining to the tag.

Step 1340 may comprise providing content to the user 143. The content provided at step 1340 may comprise the content item(s) identified at step 1330. Step 1340 may comprise providing the content through a specialized communication channel that is separate from other, general-purpose communication channels of the client device 141, such as email, text messaging, instant messaging, voice calling, and/or the like. As disclosed herein, content pertaining to tags, campaigns, and/or content feeds managed by the content distribution service 110 may be delivered through a client application 140, which may maintain and/or store such content in an inbox (e.g., local content record 512) that is separate from communication channels and/or inboxes of other, general-purpose communication channels of the user 143. Moreover, the user 143 may subscribe tags, campaigns, and/or content feeds of the content distribution service 110 without exposing personal information, such as contact information for the other, general-purpose communication channels.

Step 1350 may comprise providing follow-up content to the user 143. The follow-up content of step 1350 may be published to the content distribution service 110 by a publisher 130 (and/or an authorized entity of the publisher 130). Step 1350 may, therefore, comprise receiving a publication request 217 at the content distribution service 110. Alternatively, or in addition, step 1350 may comprise receiving follow-up content through the publisher interface 152 (e.g., interface 1150 of FIG. 11B). Step 1350 may further comprise selecting content to publish to the user 143 based on, inter alia, publication conditions associated with the follow-up content. The publication conditions may be specified by the publisher 130 by use of the publication conditions input 1162, as disclosed above. Step 1350 may comprise providing the follow-up content to the client device 141 of the user 143 through a specialized communication channel that is separate from and/or independent of other, general-purpose communication channels of the client device 141, as disclosed above.

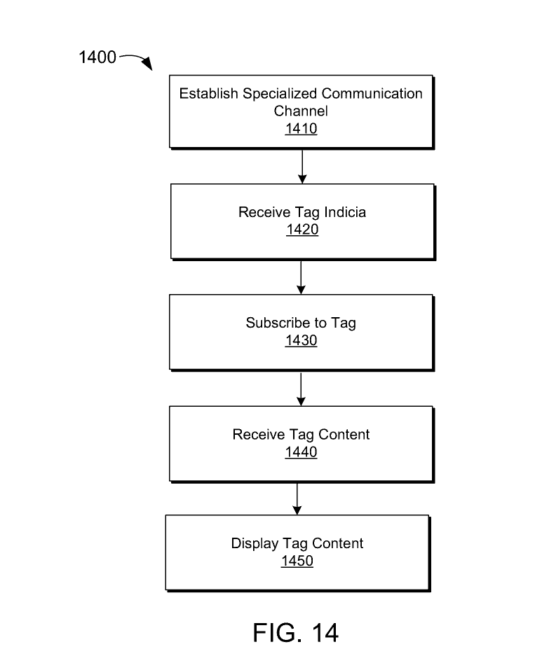

FIG. 14 is a flow diagram of another embodiment of a method 1400 for content distribution. Step 1410 may comprise establishing a specialized communication channel with the content distribution service 110. Step 1410 may comprise transferring computer-readable instructions comprising the client application 140 from a network-accessible service to a non-transitory store 113 of the client device 141. The client application 140 may comprise a communication channel to the content distribution service 110 that is separate from and/or independent of other communication channels of the client device 141 (e.g., email, text messaging, instant messaging, voice calling, and so on).

In some embodiments, step 1410 further comprises establishing a user account with the content distribution service 110. The user account may comprise an anonymous user account that does not include personally identifying information pertaining to the user 143. The user account may, however, include general demographic information pertaining to the user 143 such as gender, age, education level, and so on. In some embodiments, the user account of step 1410 comprises personally-identifying information, such as a user name, contact information, and so on.

Step 1420 comprises receiving tag indicia from the user 143. Step 1420 may comprise receiving one or more of text indicia, audio indicia, image indicia, video indicia, and/or the like. Step 1420 may further include deriving tag indicia from input data, such as converting speech to text, extracting text from an image and/or video, and/or the like. Step 1420 may be performed in response to user interaction with the client application 140 (e.g., manipulation of the subscription interface 144). In some embodiments, step 1420 is performed in response to a voice command from the user 143, as disclosed above.

Step 1430 comprises subscribing to a tag, campaign, and/or content feed in response to receiving the tag indicia. Step 1430 may comprise one or more of recording a subscription on the client device 140, transmitting a request to the content distribution service 110 (e.g., a subscription request 310 and/or content request 330), and/or the like.

Step 1440 comprises receiving content pertaining to the subscribed tag, campaign, and/or content feed. Step 1440 may comprise receiving a publication message 510 from the content distribution service 110 in response to a request. Alternatively, or in addition, step 1440 may comprise receiving a publication message 510 pushed to the client application 140 by the content distribution service 110. Step 1440 may further include storing the received content in an inbox on non-transitory store 113 of the client device 141.

Step 1450 comprises displaying content of the subscribed tag, campaign, and/or content feed on the client device 141. Step 1450 may comprise displaying a content interface 146 of the client application 140, as disclosed herein.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims:

1. An apparatus, comprising:
a server computing device comprising a processor, non-transitory storage, and a communication interface to communicatively couple the server computing device to a network, the server computing device further comprising:
a tag manager configured for operation on the processor, wherein the tag manager is configured to associate tag indicia with respective content items, including associating first tag indicia with a first content item;
a subscription manager configured for operation on the processor, wherein the subscription manager is configured to receive a subscription request from a particular client application through the communication interface, the subscription request comprising the first tag indicia; and
a publication engine configured for operation on the processor, wherein the publication engine is configured to identify the first content item associated with the first tag indicia of the subscription request, and to transmit the identified, first content item to the client application through the communication interface,
wherein the publication interface is further configured to associate a second content with the first tag indicia, and where the publication engine is configured to transmit the second content item to the particular client application through the communication interface.

2. An apparatus, comprising:
a mobile computing device comprising a processor, non-volatile storage, and a communication interface to communicatively couple the mobile computing device to a network;
a client application configured for operation on the processor of the mobile computing device, the client application comprising:
a subscription interface configured to acquire tag indicia from a user, and to transmit subscription requests to a content distribution service comprising the acquired tag indicia through the communication interface in response to acquiring the tag indicia;
a content manager configured to receive content items published to the client application in response to subscription requests; and
a content interface configured to display entries corresponding to the tag indicial acquired through the subscription interface and the content items published to the client application in response to the subscription requests.
